(19) United States
(12) Patent Application Publication
(10) Pub. No.: US 2023/0213605 A1
(43) Pub. Date: Jul. 6, 2023

(54) INFORMATION PROCESSING DEVICE AND NON-TRANSITORY COMPUTER-READABLE STORAGE MEDIUM STORING PROGRAM

(71) Applicant: SEIKO EPSON CORPORATION, Tokyo (JP)

(72) Inventors: Iwane IKEDA, Nagano-shi (JP); Hiroyuki KURAMOTO, Shiojiri-shi (JP); Yui IMAMURA, Shiojiri-shi (JP)

(21) Appl. No.: 18/149,877

(22) Filed: Jan. 4, 2023

(30) Foreign Application Priority Data
Jan. 6, 2022 (JP) 2022-001130

(51) Int. Cl. G01S 3/04; G06T 3/60

(52) U.S. Cl. CPC G01S 3/046; G06T 3/60

(57) ABSTRACT

An information processing device includes a wireless communication unit, a search result acquisition unit, a direction information acquisition unit, a map information acquisition unit, and a controller. The search result acquisition unit acquires information of a search result about an electronic device by a search via the wireless communication unit. The direction information acquisition unit acquires direction information representing a direction in which the electronic device found by the search exists, based on short-range wireless communication with the electronic device via the wireless communication unit. The map information acquisition unit acquires map information including location information of the electronic device found by the search. The controller acquires the location information of the information processing device specified based on the direction information and the map information and displays a location of the information processing device in a map image, based on the location information of the information processing device.

The present application is based on, and claims priority from JP Application Serial Number 2022-001130, filed Jan. 6, 2022, the disclosure of which is hereby incorporated by reference herein in its entirety.

### BACKGROUND

### 1. Technical Field

The present disclosure relates to an information processing device and a non-transitory computer-readable storage medium storing a program, or the like.

### 2. Related Art

According to the related art, a technique of displaying, on an information processing device, a list of electronic devices searched out based on the radio wave intensity of wireless communication, is known.

However, JP-A-2019-148955 discloses a technique that only enables a user of an information processing device to view electronic devices shown in a list, and does not disclose a technique for clarifying the positional relationship between the information processing device and the electronic devices.

### SUMMARY

An aspect of the present disclosure relates to an information processing device wirelessly communicating with an electronic device via a wireless communication unit. The information processing device includes: a search result acquisition unit acquiring information of a search result about the electronic device by a search via the wireless communication unit; a direction information acquisition unit acquiring direction information representing a direction in which the electronic device found by the search exists, based on short-range wireless communication with the electronic device via the wireless communication unit; a map information acquisition unit acquiring map information including location information of the electronic device found by the search; and a control unit acquiring the location information of the information processing device specified based on the direction information and the map information, and displaying information representing a location of the information processing device in a map image corresponding to the map information, based on the location information of the information processing device.

Another aspect of the present disclosure relates to a non-transitory computer-readable storage medium storing a program. The program causes a computer to function as: a wireless communication unit wirelessly communicating with an electronic device; a search result acquisition unit acquiring information of a search result about the electronic device by a search via the wireless communication unit; a direction information acquisition unit acquiring direction information representing a direction in which the electronic device found by the search exists, based on short-range wireless communication with the electronic device via the wireless communication unit; a map information acquisition unit acquiring map information including location information of the electronic device found by the search; and a control unit acquiring the location information of an information processing device specified based on the direction information and the map information, and displaying information representing a location of the information processing device in a map image corresponding to the map information, based on the location information of the information processing device.

### BRIEF DESCRIPTION OF THE DRAWINGS

FIG. 1 explains an example of the configuration of an information processing device, or the like.

FIG. 2 is a flowchart explaining an example of processing by the information processing device.

FIG. 3 explains an example of a map screen based on a predetermined background image.

FIG. 4 explains location information of an electronic device.

FIG. 5 explains an example of the map screen including the location information of the electronic device.

FIG. 6 is a flowchart explaining a processing example of first interrupt processing.

FIG. 7 explains another screen example of the map screen.

FIG. 8 explains another screen example of the map screen.

FIG. 9 is a flowchart explaining a processing example of location calculation processing.

FIG. 10 explains a technique for location calculation.

FIG. 11 explains another technique for location calculation.

FIG. 12 explains another technique for location calculation.

FIG. 13 explains another technique for location calculation.

FIG. 14 explains another screen example of the map screen.

FIG. 15 explains another screen example of the map screen.

FIG. 16 explains another screen example of the map screen.

FIG. 17 explains another screen example of the map screen.

FIG. 18 explains another screen example of the map screen.

FIG. 19 is a flowchart explaining a processing example of second interrupt processing.

FIG. 20 explains a technique for location correction.

FIG. 21 is another view for explaining the technique for location correction.

FIG. 22 is a block diagram explaining an example of the configuration of an information processing device, or the like, in a modification example.

FIG. 23 explains a screen example of a map information generation application.

FIG. 24 explains another screen example of the map information generation application.

### DESCRIPTION OF EXEMPLARY EMBODIMENTS

An embodiment will now be described. However, the embodiment described below should not unduly limit the contents of the present disclosure described in the claims. Not all the components described in the embodiment are necessarily essential components of the present disclosure.

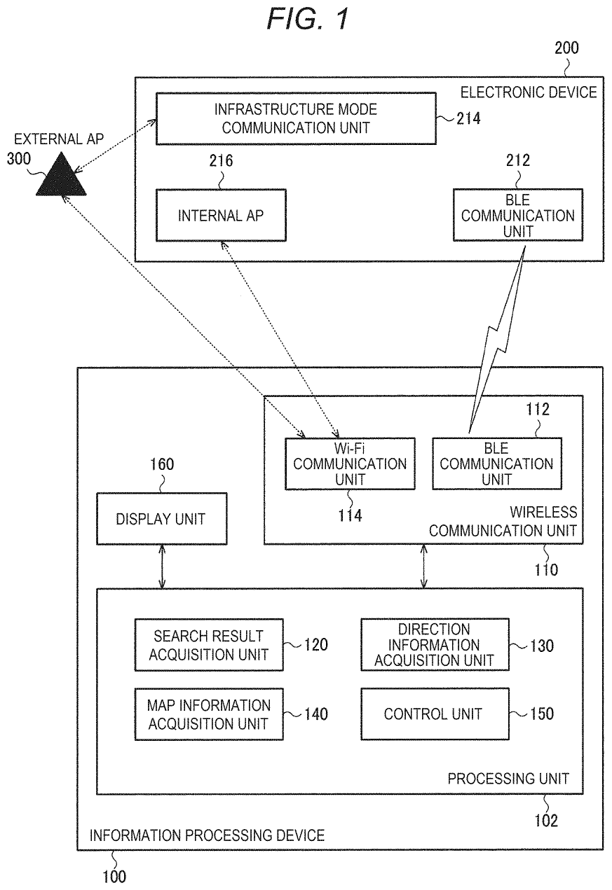

FIG. 1 is a block diagram explaining an example of the configuration of a system including an information processing device 100 and an electronic device 200 according to this embodiment. The information processing device 100 includes a processing unit 102, a wireless communication unit 110, and a display unit 160. The information processing device 100 wirelessly communicates with the electronic device 200 via the wireless communication unit 110. However, the information processing device 100 in this embodiment is not limited to the configuration shown in FIG. 1 and can be implemented with various modifications such as omitting a part of the components thereof or adding another component. The another component is, for example, an operation unit, a memory or the like. The display unit 160 is formed of a display or the like displaying various kinds of information to a user and can be implemented, for example, by a liquid crystal display, an organic EL display, a dot matrix LED or the like. Also, the display unit 160 and an operation unit, not illustrated, can be formed as an integrated piece of hardware, for example, in the form of a touch panel. The electronic device 200 is, for example, a printer but may be a personal computer, a wearable device, a biological information measuring device, a robot, a video device, or a physical quantity measuring device or the like. The wearable device refers to a smartwatch or an activity tracker or the like. The biological information measuring device refers to a pulsimeter or a pedometer or the like. The video device refers to a camera or a projector or the like. The physical quantity measuring device refers to a thermometer or a weight scale or the like. The printer in this example includes a multifunction peripheral. The multifunction peripheral refers to a printer including other functions than a printer function. The other functions than the printer function include a copy function, a facsimile function, or a scanner function or the like, and may also be other functions. The configuration of the system including the information processing device 100 and the electronic device 200 according to the embodiment is not limited to the example shown in FIG. 1. For example, the information processing device 100 may wirelessly communicate with a plurality of electronic devices 200, and the electronic device 200 may wirelessly communicate with a plurality of information processing devices 100.

The processing unit 102 controls the input and output of data from and to each functional unit including the wireless communication unit 110. The processing unit 102 executes various kinds of computational processing, based on a predetermined program read out from a memory, not illustrated, an operation input signal from an operation unit, not illustrated, or various data or the like received via the wireless communication unit 110, and controls a display output operation to the display unit 160 or a data output operation to the electronic device 200, or the like. The predetermined program refers to, for example, basic software such as an OS (operating system), various application programs operating based on the basic software, or both of these, or the like.

The processing unit 102 can be implemented by a processor. That is, each processing in this embodiment can be implemented by a processor operating based on information such as a program, and a memory, not illustrated, storing information such as a program. The processor may be, for example, individual pieces of hardware implementing functions of individual units or may be a unified piece of hardware implementing functions of individual units. For example, the processor includes hardware and the hardware can include at least one of a circuit processing a digital signal and a circuit processing an analog signal. For example, the processor can also be formed of one or a plurality of circuit devices or one or a plurality of circuit elements installed on a circuit board. The processor may be, for example, a CPU (central processing unit). However, the processor is not limited to a CPU. Various processors such as a GPU (graphics processing unit) or a DSP (digital signal processor) can be used. The processor may also be a hardware circuit formed of an ASIC. The processor may also include an amplifier circuit processing an analog signal and a filter circuit or the like.

The processing unit 102 in this embodiment includes a search result acquisition unit 120, a direction information acquisition unit 130, a map information acquisition unit 140, and a control unit 150. That is, the information processing device 100 in this embodiment includes the search result acquisition unit 120, the direction information acquisition unit 130, the map information acquisition unit 140, and the control unit 150. For example, the processing unit 102 reads out and executes an application program, described later, from a memory, not illustrated, and thus implements the functions of the search result acquisition unit 120, the direction information acquisition unit 130, the map information acquisition unit 140, and the control unit 150. When the operation of this application program needs basic software that serves as a base, the processing unit 102 may read out the program of the basic software from the memory, not illustrated, and thus may be able to implement a function, for example, as the control unit 150.

The wireless communication unit 110 is a communication interface performing wireless communication conforming to a predetermined wireless communication standard. The wireless communication unit 110 can be implemented, for example, by hardware for communication such as an ASIC (application-specific integrated circuit) for communication or a processor for communication, and firmware for communication or the like. In this embodiment, the control unit 150, described later, performs communication control processing such as transmission processing and reception processing for information, to the wireless communication unit 110, and thus enables the wireless communication unit 110 to transmit information to an external device such as the electronic device 200 and to receive information from the external device. As the predetermined wireless communication standard, a plurality of types may be employed. That is, the wireless communication unit 110 includes hardware and firmware for communication or the like corresponding to a desired wireless communication standard.

The wireless communication unit 110 can perform wireless communication conforming to a short-range wireless communication standard such as Bluetooth (trademark registered), as the predetermined wireless communication standard. In this embodiment, Bluetooth includes BLE (Bluetooth Low Energy) and may be simply referred to as BLE in the description below. For example, as shown in FIG. 1, the wireless communication unit 110 of the information processing device 100 in this embodiment includes a BLE communication unit 112 and the electronic device 200 includes a BLE communication unit 212. Thus, BLE communication can be implemented between the information processing device 100 and the electronic device 200. The BLE communication unit 112 or the like in this embodiment is in conformity with the standard of Bluetooth from version 5.1 onward. In other words, each unit included in the information processing device 100 and the electronic device 200 in this embodiment is in conformity with the standard of Bluetooth from version 5.1 onward.

The wireless communication unit 110 can also perform wireless communication conforming to, for example, Wi-Fi (trademark registered) as the predetermined wireless communication standard, in a predetermined connection mode. The predetermined connection mode is, for example, a Wi-Fi infrastructure mode. That is, as shown in FIG. 1, for example, the wireless communication unit 110 of the information processing device 100 includes a Wi-Fi communication unit 114 and the electronic device 200 includes an infrastructure mode communication unit 214. Thus, communication in the Wi-Fi infrastructure mode can be implemented via an external access point 300. In the description and illustrations below, an access point may be referred to as AP. For example, the external access point 300 periodically broadcasts a wireless communication radio wave such as a beacon in such a way that identification information of the external access point 300 can be deciphered, and connection in the Wi-Fi infrastructure mode is established by a technique, described later. The identification information of the external access point 300 is, for example, an SSID (service set identifier). In the description below, “communication connection conforming to a communication standard” is simply referred to as “connection”, where appropriate. An access point can also be referred to as a router. In the case where communication in the Wi-Fi infrastructure mode has been established, connection with the external access point 300 is automatically established even if the communication is temporarily disconnected.

The predetermined connection mode may also be a Wi-Fi Direct (trademark registered) mode. In the description and illustrations below, Wi-Fi Direct may be referred to as direct connection. For example, as shown in FIG. 1, the wireless communication unit 110 of the information processing device 100 includes the Wi-Fi communication unit 114 and the electronic device 200 includes an internal access point 216. Thus, direct connection can be implemented. That is, the electronic device 200 is an owner of a group where the information processing device 100 is a client, and the internal access point 216 functions as a software access point. For example, the internal access point 216 periodically broadcasts a wireless communication radio wave such as a beacon conforming to the direct connection standard. An advertisement packet of this wireless communication radio wave includes information such as an SSID that is the identification information of the internal access point 216. The Wi-Fi communication unit 114 executes a scan to receive the wireless communication radio wave broadcast from the internal access point 216. The scan in this case is a passive scan but may be an active scan. The Wi-Fi communication unit 114 makes a connection request to the internal access point 216. A signal for this connection request includes information such as a password corresponding to the SSID of the internal access point 216. This enables the connection between the Wi-Fi communication unit 114 and the internal access point 216. After communication via direct connection is established and this communication is temporarily disconnected, a user may be requested to configure a connection setting again for the reason that an encryption key is changed, or the like.

The above description does not preclude the inclusion of other wireless connection modes such as an ad-hoc mode, and a connection mode based on wired communication or the like, as the predetermined connection mode. At each electronic device 200, the predetermined connection mode can be arbitrarily enabled or disabled. For example, the user can enable only the Wi-Fi infrastructure mode between the information processing device 100 and the electronic device 200.

The search result acquisition unit 120 acquires information of a search result about the electronic device 200 based on a search by the wireless communication unit 110. Specifically, for example, the BLE communication unit 212 of the electronic device 200 broadcasts an advertisement packet of the BLE. The control unit 150 operating as the basic software transmits the information of the search result to the search result acquisition unit 120, based on the identification information or the like of the electronic device 200 included in the advertisement packet received via the BLE communication unit 112. In the description below, that the BLE communication unit 212 or the internal access point 216 of the electronic device 200 broadcasts the advertisement packet or the like may be simply described as that the electronic device 200 broadcasts the advertisement packet or the like.

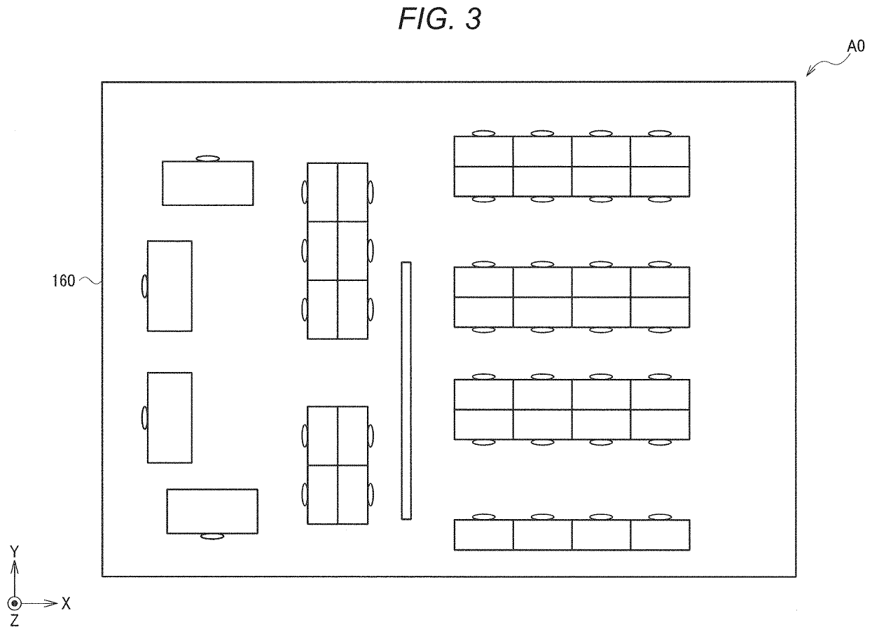

The direction information acquisition unit 130 acquires direction information representing a direction in which the electronic device 200 found by the search exists, based on the short-range wireless communication with the electronic device 200 by the wireless communication unit 110. In the description below, the direction information in this embodiment is, for example, information made up of an angle prescribed within an XY plane in an XYZ coordinate system shown in FIG. 3 or the like. Thus, the information processing device 100 can acquire the direction information of the electronic device 200 located on the same floor as the floor where the user stands.

The acquisition of the direction information can be implemented, for example, by a technique described below. For example, it is assumed that the BLE communication unit 212 of the electronic device 200 broadcasts a BLE advertisement packet, as described above, and that the BLE communication unit 112 receiving this advertisement packet includes a plurality of reception antennas. In this case, the advertisement packet reaches the individual reception antennas with a time difference. Therefore, the angle of arrival AOA of the radio wave can be estimated, based on a first computation technique using the distance between the individual antennas and the wavelength of the radio wave, which are known. The technique for estimating the angle of arrival AOA including the first computation technique is known and therefore is not described further in detail here.

The acquisition of the direction information may also be implemented, for example, by a technique described below. The BLE communication unit 212 of the electronic device 200 includes a plurality of transmission antennas and broadcasts a BLE advertisement packet while shifting the timing of transmitting the radio wave from each transmission antenna. In this case, this advertisement packet includes information of the timing when each transmission antenna transmits the advertisement packet and distance information between the individual transmission antennas. The BLE communication unit 112 can estimate the angle of departure AOD of the radio wave, based on a second computation technique using the phase difference between the advertisement packets received from the individual transmission antennas, and the information of the transmission timing and the distance information between the transmission antennas included in the advertisement packet. The technique for estimating the angle of departure AOD including the second computation technique is known and therefore is not described further in detail here.

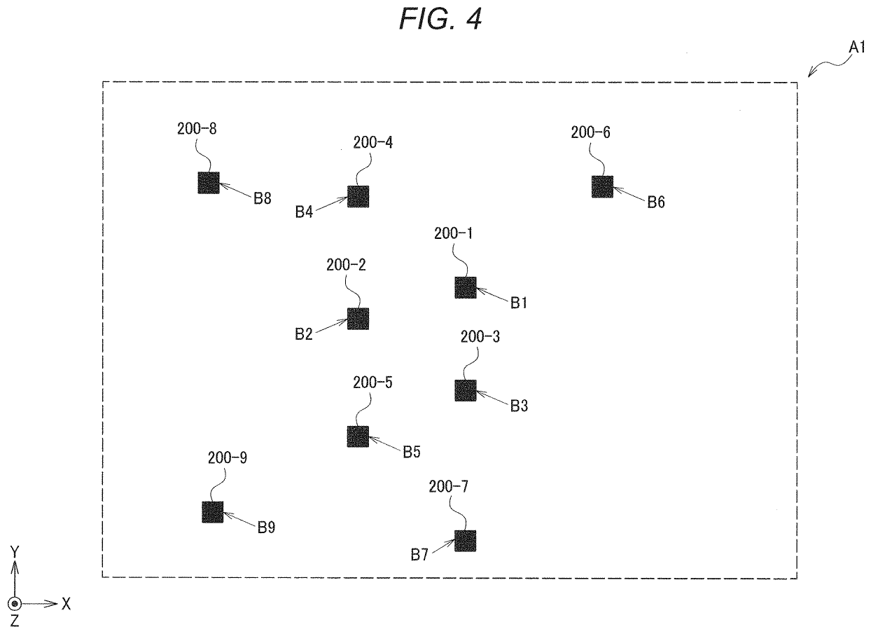

The map information acquisition unit 140 acquires map information including location information of the electronic device 200 found by the search. A map screen, described later, is displayed based on the map information. The map information acquisition unit 140 reads out image data of a background image, described later with reference to FIG. 3, and the location information of the electronic device 200, described later with reference to FIG. 4, or the like, from the memory, not illustrated, according to need, then associates the image data and the location information or the like with scale information and azimuth information or the like, described later, and thus acquires the result as the map information corresponding to the map screen that is displayed.

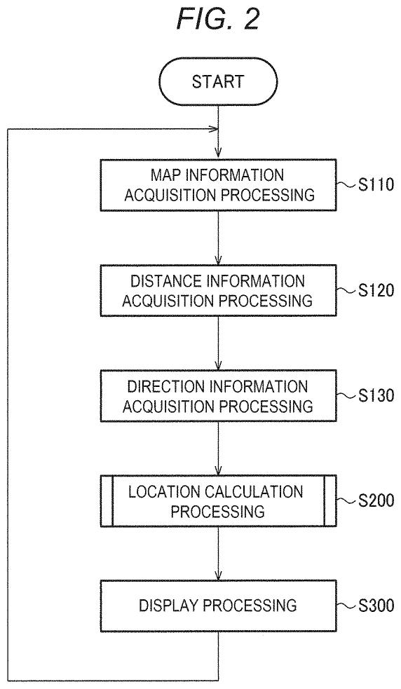

The control unit 150 performs display control of the display unit 160, based on the search information, the direction information, and the map information or the like. For example, the control unit 150 performs processing of displaying a map screen on the display unit 160, based on the map information acquired by the map information acquisition unit 140. Thus, the control unit 150 displays, for example, an icon or the like corresponding to a desired electronic device 200 as superimposed at a desired position on the background screen in the map screen. The control unit 150 may also function as basic software or the like serving as the base for a map display application. The function as the basic software or the like is, for example, a function of converting azimuth information acquired based on a geomagnetic sensor or a gyro sensor or the like, not illustrated, into an azimuth image displayed on the map display application, or the like. The function as the basic software or the like may also be a function of converting various kinds of information of the electronic device 200 included in the BLE advertisement packet into the form of a corresponding icon on the map display application, or the like, as described later. The control unit 150 can also specify a location of the information processing device 100, based on the direction information and the map information, and can acquire location information of the information processing device 100, by a technique described later with reference to the illustrations from FIG. 2 onward. The control unit 150 also displays an icon that is information corresponding to the information processing device 100, as superimposed on the map screen, based on the location information of the information processing device 100.

An example of processing relating to the display of the map screen in this embodiment will now be described, using the flowchart of FIG. 2. The information processing device 100 repeatedly executes each processing in the form of loop processing, for example, from the timing when the user starts up the application program for displaying the map screen. However, this is not limiting. The information processing device 100 may repeatedly execute each processing, for example, by generating timer interrupt processing every predetermined time.

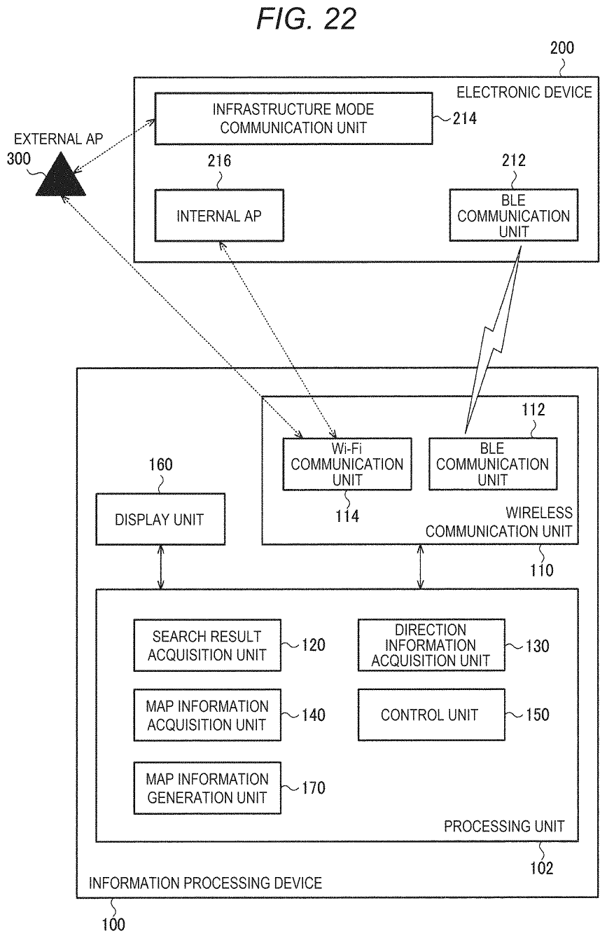

The information processing device 100 executes map information acquisition processing (step S110). For example, the map information acquisition unit 140 reads out a predetermined background image from the memory, not illustrated, and acquires the predetermined background image as information corresponding to the background image of the map screen. For example, as the processing shown in FIG. 2 is executed based on the predetermined background image when the electronic device 200 is not found based on a search result, described later, the map screen is displayed, for example, as a screen example as shown in A0 in FIG. 3. Also, for example, the map information acquisition unit 140 reads out and acquires scale information and azimuth information corresponding to the predetermined background image, from the memory, not illustrated. The scale information in this case is information for converting the distance information acquired by the control unit 150 from various sensors into a distance on the map screen. The azimuth information is information for converting the azimuth information acquired by the control unit 150 from various sensors into an azimuth on the map screen. Thus, as the information processing device 100 executes display processing (step S300), described later, the predetermined background image is displayed on the display unit 160 as the map screen including coordinate information and azimuth information. In FIG. 3, the horizontal direction is defined as an X-direction and the vertical direction is defined as a Y-direction. The same applies to the illustrations from FIG. 4 onward. Although not illustrated, a predetermined azimuth image is displayed so that the user can recognize which azimuth an X-axis and a Y-axis on the map screen correspond to. The predetermined background image corresponding to map image shown in A0 in FIG. 3 is created by the user in advance. However, the predetermined background image may be able to be created by the user in a simple manner on the map screen application. Details thereof will be described later with reference to FIG. 22 and the like.

In the map information acquisition processing (step S110), search processing for the electronic device 200 is executed. That is, the search result acquisition unit 120 acquires information of the search result, based on the identification information or the like of the electronic device 200 included in the BLE advertisement packet broadcast by the electronic device 200. The identification information of the electronic device 200 included in the information of the search result does not necessarily coincide with the identification information of the electronic device 200 stored in the memory, not illustrated. For example, when a mobile electronic device 200, described later, is included in the information of the search result, the identification information of this mobile electronic device 200 is not stored in the memory, not illustrated. Also, for example, identification information of an electronic device 200 whose power is off, or the like, is not included in the information of the search result even if this identification information is stored in the memory, not illustrated. This is because the search processing is executed on the assumption that a BLE radio wave is outputted.

The control unit 150 transmits the location information of the electronic device 200 included in the information of the search result to the map information acquisition unit 140. The location information of the electronic device 200 is stored in the memory, not illustrated, for example, in association with information corresponding to the X-coordinate and the Y-coordinate on the map screen and the identification information of the electronic device 200. The identification information of the electronic device 200 is specifically, for example, a MAC address of the electronic device 200 stored in a payload of a protocol data unit in the advertisement packet, but may be other information that is interconvertible with the MAC address, such as a serial number. In this embodiment, the payload may further include other information. This other information is, for example, information of radio wave intensity, information representing the status of the electronic device 200, or the like. Details thereof will be described later.

For example, if the map information relating to the predetermined background image is not acquired and the processing shown in FIG. 2 is executed based on the location information of the electronic device 200 included in the information of the search result, a predetermined icon group is displayed in a predetermined area surrounded by a dashed line, for example, as shown in A1 in FIG. 4. It is assumed that the size of the area indicated by the dashed line in A1 is the same as the size of the map image shown in A0 in FIG. 3. An icon indicating an electronic device 200-1 is located at a location indicated by Bl. An icon indicating an electronic device 200-2 is located at a location indicated by B2. An icon indicating an electronic device 200-3 is located at a location indicated by B3. Similarly, an icon indicating an electronic device 200-4 is located at a location indicated by B4. An icon indicating an electronic device 200-5 is located at a location indicated by B5. An icon indicating an electronic device 200-6 is located at a location indicated by B6. Similarly, an icon indicating an electronic device 200-7 is located at a location indicated by B7. An icon indicating an electronic device 200-8 is located at a location indicated by B8. An icon indicating an electronic device 200-9 is located at a location indicated by B9. Although not illustrated, an icon indicating an electronic device 200 that is not found by the search processing is not displayed on the map image even if the location information of this electronic device 200 is stored in the memory. That is, in A1 in FIG. 4, the electronic devices 200-1 to 200-9 are electronic devices 200 whose identification information and location information are stored in the memory, not illustrated, and that are found by the search processing.

The information processing device 100 then executes distance information acquisition processing (step S120). For example, when the BLE communication unit 112 receives a radio wave based on BLE, the BLE advertisement packet includes the identification information of the electronic device 200 and reference radio wave intensity information. Therefore, the control unit 150 can acquire distance information between the information processing device 100 and the electronic device 200. The reference radio wave intensity is the received signal strength indication (RSSI) of a beacon signal at a receiving-side device installed at a location away from a transmitting-side device of the beacon signal by a reference distance. The radio wave intensity is in inverse proportion to the square of the distance. Therefore, if the radio wave intensity at the reference distance is known, the control unit 150 can compute the specific distance between the information processing device 100 and the electronic device 200 outputting the beacon signal, based on the radio wave intensity of the BLE beacon signal actually received by the BLE communication unit 112. The control unit 150 then converts the specific distance between the information processing device 100 and the electronic device 200 into a distance on the map screen, using the scale information, and acquires the result as the distance information corresponding to the map information. The electronic device 200 to be a target of the distance information acquisition processing (step S120) is the electronic device 200 found by the search processing in the map information acquisition processing (step S110). Therefore, the control unit 150 can also acquire the distance information of, for example, a mobile electronic device 200 whose information is not stored in the memory, not illustrated.

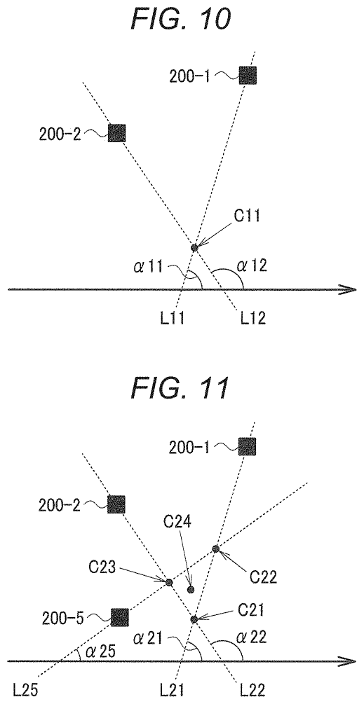

Subsequently, the information processing device 100 executes direction information acquisition processing (step S130). For example, when the BLE communication unit 112 receives an advertisement packet conforming to the BLE standard from the electronic device 200, the control unit 150 calculates the angle of arrival AOA or the angle of departure AOD that is estimated by the technique described above. The control unit 150 then executes processing of converting the angle of arrival AOA or the angle of departure AOD into direction information corresponding to the map screen, described later, and transmits the direction information to the direction information acquisition unit 130. For example, the control unit 150 executes processing of converting the angle of arrival AOA or the angle of departure AOD, which is relative information found based on the information processing device 100 or the electronic device 200 as a reference point, into the direction information corresponding to the map screen. Thus, the direction information acquisition processing (step S130) can be implemented. The direction information acquisition unit 130 acquires the direction information, for example, in the form of information of an angle made up of a number on assumption that a predetermined angle direction from a predetermined axis on the map screen is positive. For example, in FIG. 10, described later, the direction information acquisition unit 130 acquires the direction information of the electronic device 200-1 in the form of an angle all from the horizontal axis, or the like. The electronic device 200 to be a target of the direction information acquisition processing (step S130) is the electronic device 200 found by the search processing in the map information acquisition processing (step S110). Therefore, the control unit 150 can also acquire the direction information of, for example, a mobile electronic device 200 whose information is not stored in the memory, not illustrated.

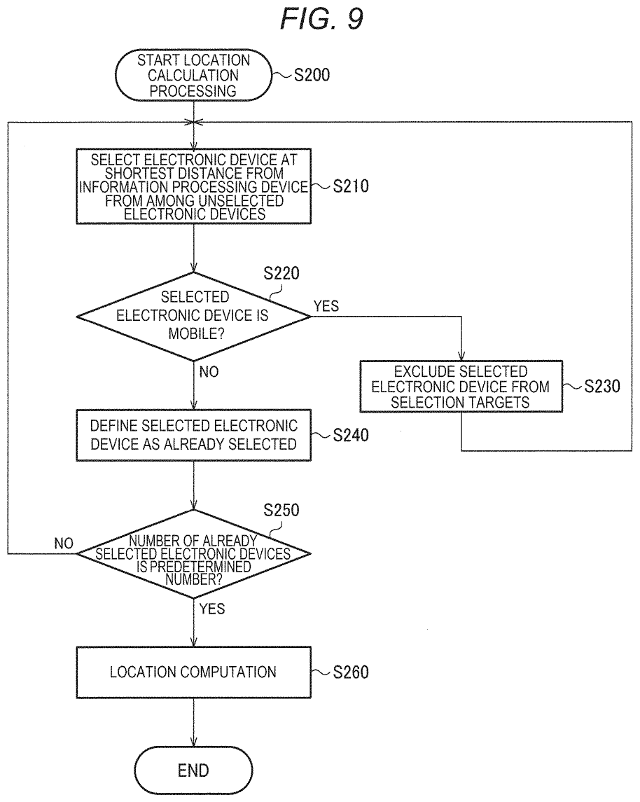

Subsequently, the information processing device 100 executes location calculation processing (step S200). While this processing will be described more in detail later with reference to FIG. 9, the control unit 150 executes processing of calculating the location of the information processing device 100, based on the direction information or the like of a predetermined number of predetermined electronic devices 200, of the electronic devices 200 found by the search processing. The predetermined number will be described later with reference to FIG. 9. The predetermined electronic device 200 in this case is an electronic device 200 that is suitable as a reference point for the calculation of the location of the information processing device 100, and more specifically, a fixed-location electronic device 200.

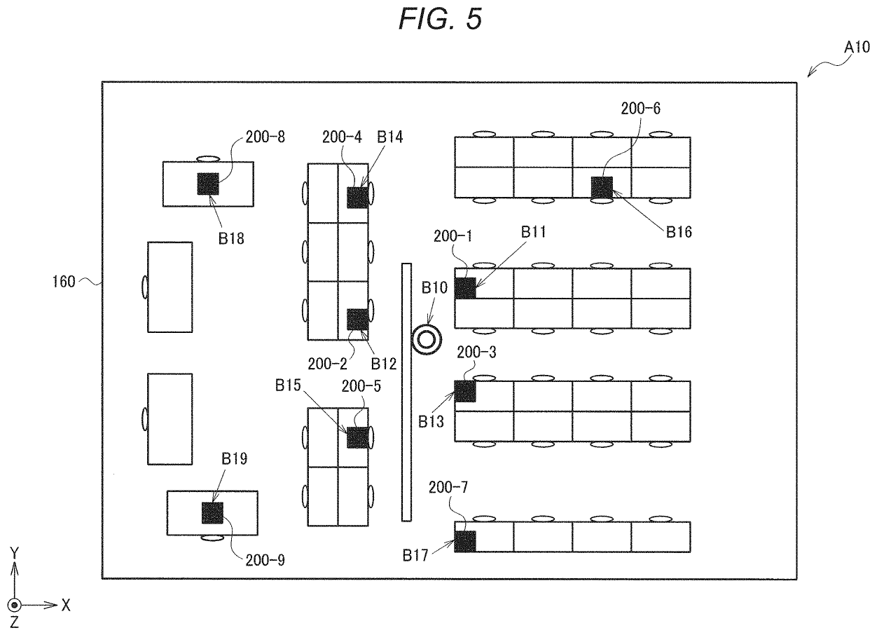

Subsequently, the information processing device 100 execute display processing (step S300). Specifically, for example, the control unit 150 executes processing of displaying a map screen on the display unit 160, based on the map information acquired by the map information acquisition processing (step S110) and the location information of the information processing device 100 calculated by the location calculation processing (step S200). The control unit 150 displays information representing the location of the information processing device 100 on the map screen, based on the location information of the information processing device 100. The information representing the location of the information processing device 100 is, for example, an image icon. Thus, for example, a map screen as shown in a screen example of A10 in FIG. 5 is displayed. A10 in FIG. 5 shows that this is a screen example where an icon indicating the information processing device 100 is displayed at a location indicated by B10 on the map screen with the screen of A0 in FIG. 3 and the screen example of A1 in FIG. 4 superimposed together.

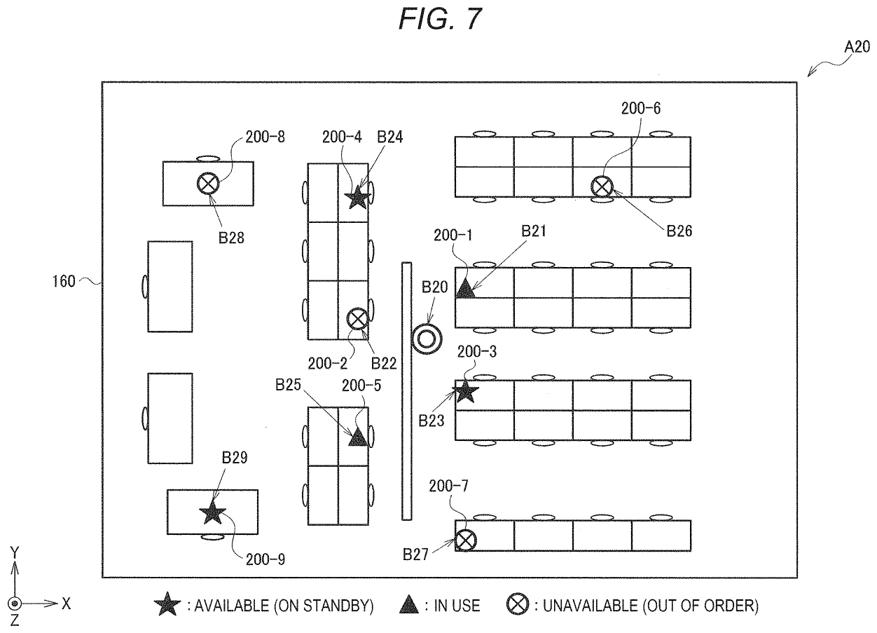

As described above, the example of processing shown in FIG. 2 is periodically repeated. Therefore, the display example shown in FIG. 5 or the like is periodically updated and the display content may be changed due to a predetermined circumstance. The predetermined circumstance is, for example, a circumstance where the power of one of the electronic devices 200 has turned on or off, a circumstance where the electronic device 200 has an unexpected malfunction, a circumstance where the distance information, the direction information or the like is changed due to a movement of the user holding the information processing device 100, or the like. The same applies to display examples in modification examples or the like described later with reference to the illustrations from FIG. 7 onward.

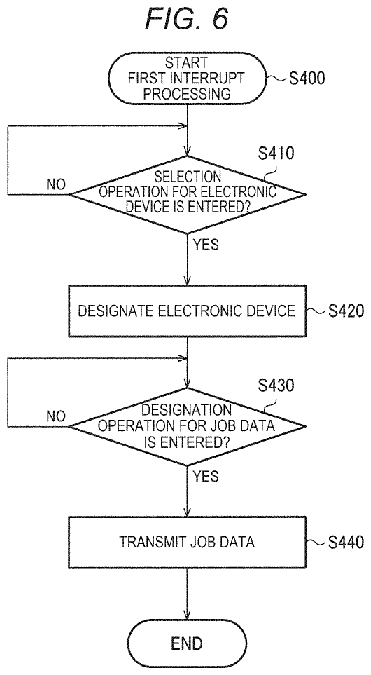

Subsequently, the user selects a desired electronic device 200 from the screen of A10 in FIG. 5 and executes a job. For example, first interrupt processing (step S400) shown in the flowchart of FIG. 6 can implement the execution of a job. The control unit 150 executes processing of determining whether a selection operation for the electronic device 200 is entered or not (step S410). For example, the control unit 150 determines whether the user has selected one of the icons indicated by B11 to B19 on the screen of A10 in FIG. 5 or not. When a selection operation for the electronic device 200 is not entered (NO in step S410), the control unit 150 executes step S410 again. Meanwhile, when a selection operation for the electronic device 200 is entered (YES in step S410), the control unit 150 designates the electronic device 200 (step S420). For example, the control unit 150 executes processing of displaying a job execution screen for the electronic device 200 selected by the user, on the display unit 160, or the like, though not illustrated. Subsequently, the control unit 150 executes processing of determining whether a designation operation for job data is entered or not (step S430). For example, the control unit 150 determines whether any of job data, not illustrated, that are listed in the job execution screen, is selected or not. When a designation for job data is not entered (NO in step S430), the control unit 150 executes step S430 again. Meanwhile, when a designation operation for job data is entered (YES in step S430), the control unit 150 executes processing of transmitting the designated job data to the electronic device 200 (step S440). In the case where the information processing device 100 and the electronic device 200 are connected based on BLE, processing of a handover from BLE to Wi-Fi may be added before the execution of step S440. This enables the information processing device 100 to transmit the job data having a large volume to the electronic device 200.

As described above, the information processing device 100 in this embodiment wirelessly communicates with the electronic device 200 via the wireless communication unit 110. The information processing device 100 includes the search result acquisition unit 120, the direction information acquisition unit 130, the map information acquisition unit 140, and the control unit 150. The search result acquisition unit 120 acquires information of a search result about the electronic device 200 based on a search by the wireless communication unit 110. The direction information acquisition unit 130 acquires direction information representing the direction in which the electronic device 200 found by the search exists, based on short-range wireless communication with the electronic device 200 via the wireless communication unit 110. The map information acquisition unit 140 acquires map information including location information of the electronic device 200 found by the search. The control unit 150 acquires location information of the information processing device 100 specified based on the direction information and the map information, and displays information representing the location of the information processing device 100 in a map image corresponding to the map information, based on the location information of the information processing device 100.

In this way, the information processing device 100 in this embodiment includes the wireless communication unit 110 and the search result acquisition unit 120 and therefore can search for the electronic device 200 that is connectable via wireless communication, based on information or the like included in a packet of wireless communication radio wave. The information processing device 100 in this embodiment also includes the direction information acquisition unit 130, the map information acquisition unit 140, and the control unit 150, and therefore can display map information mapping a location of the electronic device 200, based on direction information. The control unit 150 acquires location information of the information processing device 100 specified based on the direction information and the map information, and displays a location of the information processing device 100 on a map image, based on the location information. Therefore, the user can grasp the location of the information processing device 100 in the map image in detail. Thus, the user can grasp the positional relationship of the electronic device 200 in the map image more in detail. Therefore, for example, when a plurality of electronic devices 200 exist in the map image, the user can properly determine which electronic device 200 to select. Up to now, the information processing device 100 calculating the location of the information processing device 100, based on the direction information and the map information, and displaying the location of the information processing device 100 on the map screen, has not been proposed.

The technique in this embodiment may be implemented by a program. That is, the program in this embodiment causes a computer to function as the wireless communication unit 110, the search result acquisition unit 120, the direction information acquisition unit 130, the map information acquisition unit 140, and the control unit 150. The wireless communication unit 110 wirelessly communicates with the electronic device 200. The search result acquisition unit 120 acquires information of a search result about the electronic device 200 searched out by the wireless communication unit 110. The direction information acquisition unit 130 acquires direction information representing a direction in which the electronic device 200 found by the search exists, based on short-range wireless communication with the electronic device 200 via the wireless communication unit 110. The map information acquisition unit 140 acquires map information including location information of the electronic device 200 found by the search. The control unit 150 acquires location information of the information processing device 100 specified based on the direction information and the map information, and displays information representing a location of the information processing device 100 in a map image corresponding to the map information, based on the location information of the information processing device 100. Thus, an effect similar to the above can be achieved.

The technique in this embodiment can be implemented with various modifications. For example, display processing of changing the form of the icon according to the status of the electronic device 200, as in a screen example shown in A20 in FIG. 7, may be added. The status in this case can also be referred to as the state. For example, an icon of the electronic device 200-1 indicated by B21 and an icon of the electronic device 200-5 indicated by B25 are displayed in a form indicating that the electronic device 200 is in use. Also, for example, an icon of the electronic device 200-2 indicated by B22, an icon of the electronic device 200-6 indicated by B26, an icon of the electronic device 200-7 indicated by B27, and an icon of the electronic device 200-8 indicated by B28 are displayed in a form indicating that the electronic device 200 is unavailable because it is out of order or for similar reasons. Also, for example, an icon of the electronic device 200-3 indicated by B23, an icon of the electronic device 200-4 indicated by B24, and an icon of the electronic device 200-9 indicated by B29 are displayed in a form indicating that the electronic device 200 is available and on standby. The control unit 150 may also execute display processing of changing the form of the icon of the electronic device 200 that has been connected in the past and not changing the form of the icon of the electronic device 200 that has never been connected in the past.

For example, the BLE communication unit 212 of the electronic device 200 monitors the status of its own electronic device 200, stores information corresponding to the status in the payload, and broadcasts the BLE advertisement packet. Subsequently, the BLE communication unit 112 receives this advertisement packet and the control unit 150 reads out icon data corresponding to the status, of the icon data stored in the memory, not illustrated, based on the information corresponding to the status of the electronic device 200 included in the advertisement packet. The control unit 150 then can implement the display of the screen example shown in A20 in FIG. 7 by a technique such as executing display processing of arranging the icon data at a predetermined position on the map screen, based on the location information of the electronic device 200 acquired by the map information acquisition unit 140.

As described above, in the information processing device 100 in this embodiment, the control unit 150 changes the display form of the image of the electronic device 200 in the map image according to the status of the electronic device 200. Thus, the user can further take the status of the electronic device 200 into account and therefore can select the electronic device 200 more properly. For example, in the case of the screen example of A20 in FIG. 7, the user is located at a location indicated by B20 and therefore can recognize that the electronic device 200 that is near the user and available is the electronic device 200-3. The user can also recognize that the electronic device 200-1 is located at a location near the user but is in use and therefore is not suitable for selection.

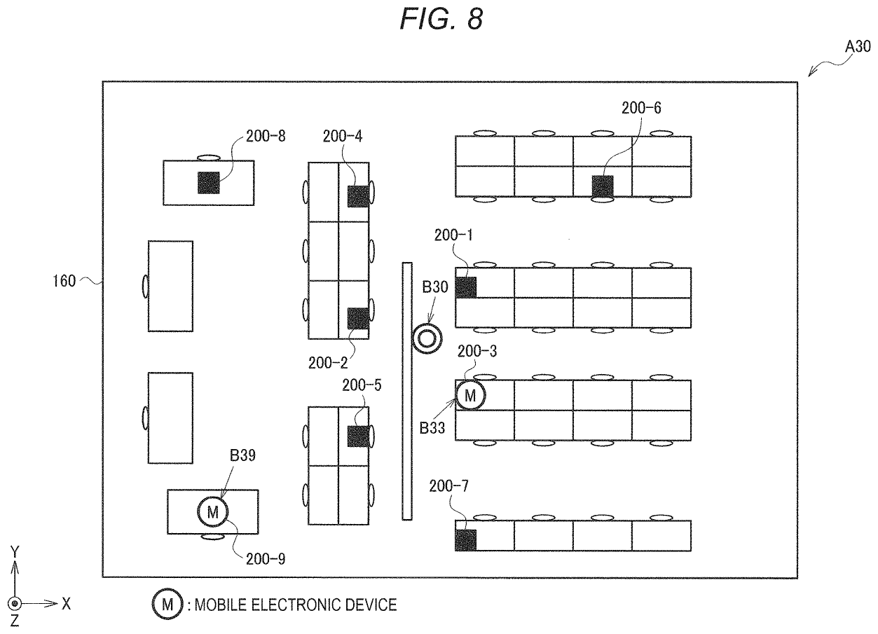

Also, display processing of changing the form of the icon according to whether the electronic device 200 is mobile or not, as in a screen example shown in A30 in FIG. 8, may be added. The mobile electronic device 200 refers to, for example, an electronic device 200 that can be carried by an arm of a human having average physical strength. Whether the electronic device 200 is mobile or not can be determined, for example, based on the identification information or the like of the electronic device 200 acquired by the search result acquisition unit 120. In FIG. 8, an icon of the electronic device 200-3 indicated by B33 and an icon of the electronic device 200-9 indicated by B39 are displayed in a form indicating that the electronic device 200 is a mobile electronic device 200. In this way, in the information processing device 100 in this embodiment, the control unit 150 changes the display form of the image of the electronic device 200 in the map image according to whether the electronic device 200 is mobile or not. Thus, the user can further take into account whether the electronic device 200 is mobile or not. Therefore, the user can select the electronic device 200 more properly. For example, when the user searches for a mobile electronic device 200, the user need not directly examine whether the electronic device 200 is a mobile electronic device 200 or not, with respect to all the electronic devices 200-1 to 200-9 shown in the screen example of A30 in FIG. 8. Also, the user is located at a location indicated by B30 and therefore can recognize that the electronic device 200 that is near the user and mobile is the electronic device 200-3. The user can also recognize that the electronic device 200-9 is a mobile electronic device 200 but is located at a location far from the user and therefore is not suitable for selection.

As described above, the identification information or the like of the mobile electronic device 200 is not stored in the memory, not illustrated, and therefore is not included in the map information acquired by the map information acquisition unit 140. However, since the mobile electronic device 200 is found by the search processing included in the map information acquisition processing (step S110), the distance information and the direction information of the mobile electronic device 200 are acquired, as described above. Therefore, in the display processing (step S300), the control unit 150 can associate the location information of the mobile electronic device 200 with the map information, based on the location information of the information processing device 100 calculated by the location calculation processing (step S200). The control unit 150 then, for example, reads out icon data corresponding to the mobile electronic device 200, of the icon data stored in the memory, not illustrated, and can implement the display of the screen example shown in A30 in FIG. 8 by a technique such as executing display processing of arranging the icon data at a predetermined position on the map screen. The predetermined position can be found from the distance information and the direction information acquired by the map information acquisition processing (step S110) and the distance information acquisition processing (step S120), based on the location information of the information processing device 100.

As described above, in the information processing device 100 in this embodiment, when the control unit 150 has detected a mobile electronic device 200, which is another electronic device 200 not included in the map information, the control unit 150 executes processing of displaying an image of the mobile electronic device 200, which is another electronic device 200, on the map image, based on the direction information of the mobile electronic device 200, which is another electronic device 200, the map information, and the location information of the information processing device 100. Thus, the user can grasp another electronic device 200 not included in the map information, on the map screen. This can improve the convenience of the information processing device 100.

Details of the location calculation processing (step S200) will now be described, using FIGS. 9, 10, and 11. The control unit 150 executes processing of selecting an electronic device 200 at the shortest distance from the information processing device 100 from among unselected electronic devices 200 (step S210). The selecting in this case refers to selecting an electronic device 200 used for location computation (step S260), described later. The control unit 150 then executes processing of determining whether the selected electronic device 200 is a mobile electronic device 200 or not (step S220). When the selected electronic device 200 is a mobile electronic device 200 (YES in step S220), the control unit 150 executes processing of excluding the selected electronic device 200 from the selection target (step S230) and executes step S210 again. This is because the mobile electronic device 200 may be changed in location and therefore is not suitable for use in the processing of finding the location of the information processing device 100. Meanwhile, when the selected electronic device 200 is not a mobile electronic device 200 (NO in step S220), the control unit 150 executes processing of defining the selected electronic device 200 as already selected (step S240). The control unit 150 then executes processing of determining whether the number of selected electronic devices 200 has reached a predetermined number or not (step S250). When the number of already selected electronic devices 200 has not reached the predetermined number (NO in step S250), the control unit 150 executes the processing of step S210 again. The predetermined number will be described later with reference to FIGS. 10 and 11. Meanwhile, when the number of already selected electronic devices 200 has reached the predetermined number (YES in step S250), the control unit 150 executes location computation (step S260).

The processing of location computation (step S260) can be implemented, for example, by techniques shown in FIGS. 10 and 11. For example, it is assumed that the predetermined number is two and that the control unit 150 selects the electronic device 200-1 and the electronic device 200-2 in step S240 in FIG. 9. It is also assumed that the direction information of the electronic device 200-1 acquired by the direction information acquisition unit 130 in step S130 in FIG. 2 is an angle all from the horizontal axis and that the direction information of the electronic device 200-2 is an angle α12 from the horizontal axis. Since the location information of the electronic device 200-1 is known, an imaginary line L11 forming the angle α11 to the horizontal axis can be drawn from the location of the electronic device 200-1. Similarly, an imaginary line L12 forming the angle α12 to the horizontal axis can be drawn from the location of the electronic device 200-2. In this case, the control unit 150 estimates location information based on a point of intersection between the line L11 and the line L12, indicated by C11, as the location information of the information processing device 100.

When the predetermined number in step S250 is three, the processing of location computation (step S260) can be implemented, for example, by a technique shown in FIG. 11. For example, it is assumed that the control unit 150 selects the electronic device 200-1, the electronic device 200-2, and the electronic device 200-5 in step S240. It is also assumed that the direction information of the electronic device 200-1 acquired by the direction information acquisition unit 130 in the direction information acquisition processing (step S130) in FIG. 2 is an angle α21 from the horizontal axis, that the direction information of the electronic device 200-2 is an angle α22 from the horizontal axis, and that the direction information of the electronic device 200-5 is an angle α25 from the horizontal axis. Thus, as in the case of FIG. 10, an imaginary line L21 forming the angle α21 to the horizontal axis can be drawn from the location of the electronic device 200-1. An imaginary line L22 forming the angle α22 to the horizontal axis can be drawn from the location of the electronic device 200-2. An imaginary line L25 forming the angle α25 to the horizontal axis can be drawn from the location of the electronic device 200-5. In this case, the control unit 150 estimates a point indicated by C24 as the location of the information processing device 100. The coordinates of the point indicated by C24 are the average of the coordinates of a point of intersection between the line L21 and the line L22, indicated by C21, the coordinates of a point of intersection between the line L21 and the line L25, indicated by C22, and the coordinates of a point of intersection between the line L22 and the line L25, indicated by C23. Thus, for example, in a circumstance where the location information and the direction information that are acquired include an error, the location of the information processing device 100 can be estimated more accurately. The circumstance where the location information and the direction information include an error is, for example, a circumstance where the BLE signal includes a noise, or the like.

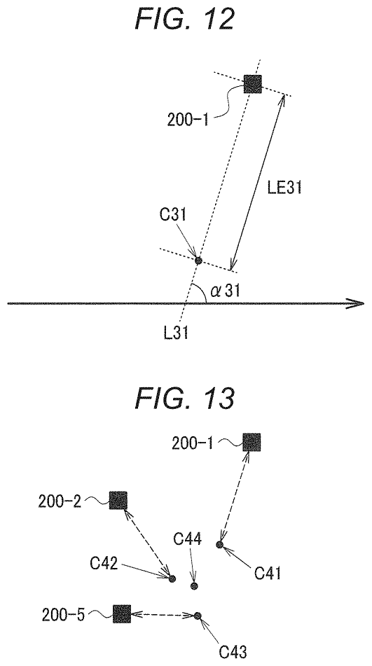

Also, in consideration of the distance information, the processing of location computation (step S260) may be implemented, for example, by a technique shown in FIG. 12. Specifically, for example, it is assumed that the predetermined number is one and that the control unit 150 selects the electronic device 200-1 in step S240. It is also assumed that the direction information of the electronic device 200-1 acquired by the direction information acquisition unit 130 in the direction information acquisition processing (step S130) in FIG. 2 is an angle α31 from the horizontal axis. Thus, as in the cases of FIGS. 10 and 11, an imaginary line L31 forming the angle α31 to the horizontal axis can be drawn from the location of the electronic device 200-1. Also, the distance information of the electronic device 200-1, that is, a distance converted onto the map screen, using the distance actually measured based on the BLE radio wave sent out from the electronic device 200-1 and the scale information, is defined as a distance LE31. In this case, a point on the line L31 away from the electronic device 200-1 by the distance LE31, as indicated by C31, is estimated as the location of the information processing device 100.

Also, for example, when the predetermined number is two or more, the processing of location computation (step S260) may be implemented by a technique shown in FIG. 13. As in the example shown in FIG. 11, it is assumed that the predetermined number is three and that the control unit 150 selects the electronic device 200-1, the electronic device 200-2, and the electronic device 200-5 in step S240. A point indicated by C41 is a point indicating the location of the information processing device 100 estimated from the electronic device 200-1 by a technique similar to that in FIG. 12. A point indicated by C42 is a point indicating the location of the information processing device 100 estimated from the electronic device 200-2. A point indicated by C43 is a point indicating the location of the information processing device 100 estimated from the electronic device 200-5. In this case, the control unit 150 estimates a point indicated by C44 as the ultimate location of the information processing device 100. The coordinates of the point indicated by C44 are the average of the coordinates of the point indicated by C41, the coordinates of the point indicated by C42, and the coordinates of the point indicated by C43. Thus, the location of the information processing device 100 can be estimated more accurately.

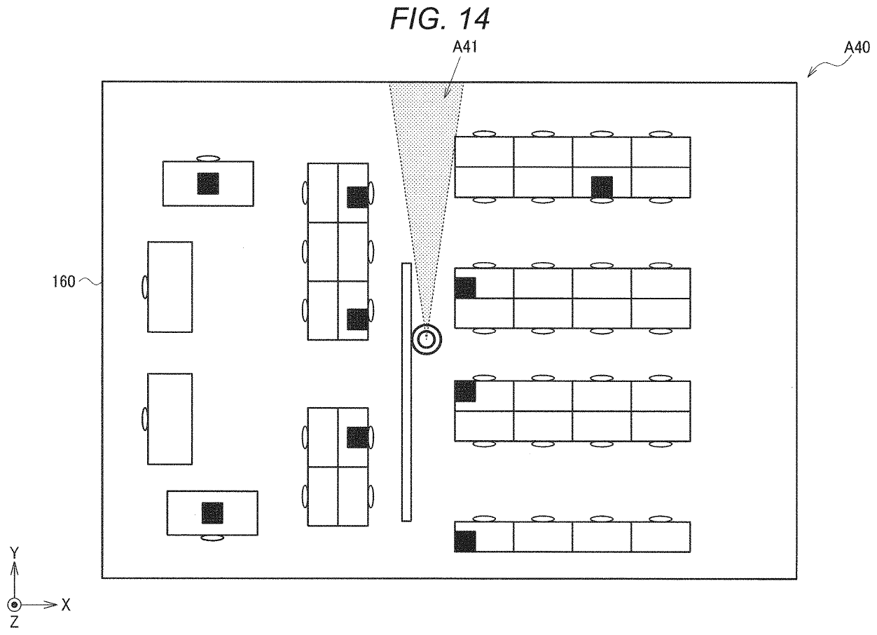

The technique in this embodiment is not limited to the above and can be implemented with various modifications. For example, information representing which direction the information processing device 100 faces may be displayed. Specifically, in a screen example shown in A40 in FIG. 14, a predetermined azimuth image indicated by A41 may be displayed as superimposed thereon in such a way as to correspond to the direction in which the top end of the information processing device 100 faces. For example, the control unit 150 executes processing of acquiring a detection value from a geomagnetic sensor or a gyro sensor, not illustrated, then finding an azimuth angle based on the detection value, and generating an azimuth image based on the azimuth angle, and thus can implement the display of the screen example shown in A40. However, the form of the azimuth image is not limited to A41 and may be able to be suitably set by the user. The technique of finding the azimuth angle based on the detection value from the geomagnetic sensor or the gyro sensor is known and therefore is not described further in detail here.

As described above, in the information processing device 100 in this embodiment, the control unit 150 displays the information representing the direction of the information processing device 100 in the map image. Thus, the user can grasp which direction the information processing device 100 faces.

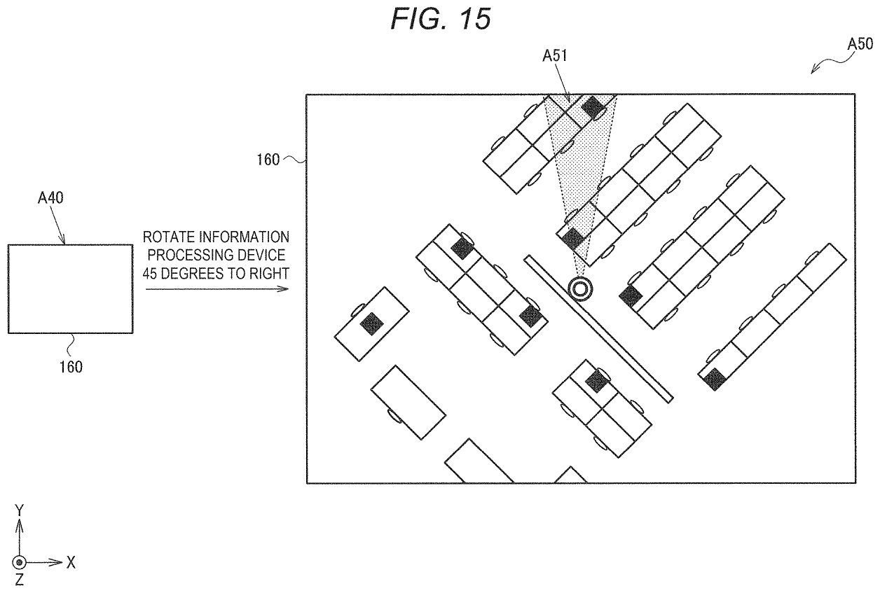

Also, for example, when the information processing device 100 is rotated 45 degrees to the right in the state where the screen example of A40 in FIG. 14 is displayed, the control unit 150 may execute processing of displaying an image as shown in a screen example of A50 in FIG. 15. That is, the control unit 150 may execute processing of displaying the map image rotated 45 degrees to the left while keeping the direction of the azimuth image similar to A41 in FIG. 14, as indicated by A51. For example, though the presentation of a mathematical formula or the like is omitted, the display of the screen example shown in A50 can be implemented by executing processing of computing the product of a coordinate vector forming the map image and a predetermined rotation matrix, or the like, based on information of the angle of rotation of the information processing device 100 acquired from the gyro sensor or the like, not illustrated.

In this way, in the information processing device 100 in this embodiment, the control unit 150 executes the rotation processing for the map image, based on the direction of the information processing device 100. Thus, the map image based on the direction in which the information processing device 100 faces as a reference position can be displayed. Therefore, the user holding the information processing device 100 can easily grasp the existence of the electronic device 200 or the like when the direction in which the information processing device 100 faces is changed.

The technique in this embodiment is not limited to the above. For example, processing of differentiating the form of the icon between the electronic device 200 located at a location near the information processing device 100 and the electronic device 200 located at a location far from the information processing device 100 may be executed. The relationship between the near location and the far location is, for example, a relative relationship based on the distance calculated in the distance information acquired based on the radio wave intensity of BLE or the like by the distance information acquisition processing (step S120) shown in FIG. 2. However, this is not limiting. For example, the near location and the far location may be decided, considering the direction in which the information processing device 100 faces or the like. The electronic device 200 located at a location at a predetermined distance from the information processing device 100 may be referred to as a first electronic device. The electronic device 200 located at a location farther from the information processing device 100 than the first electronic device may be referred to as a second electronic device.

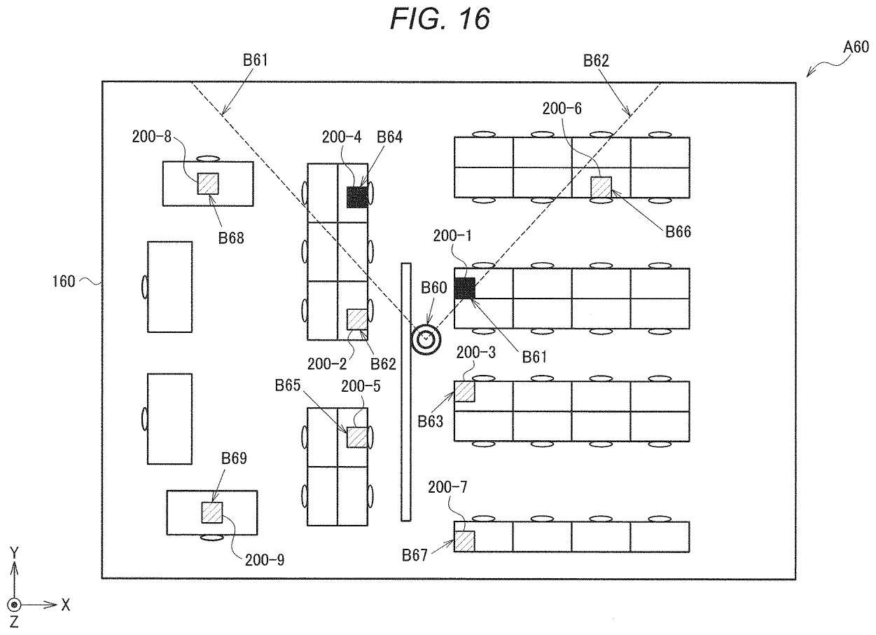

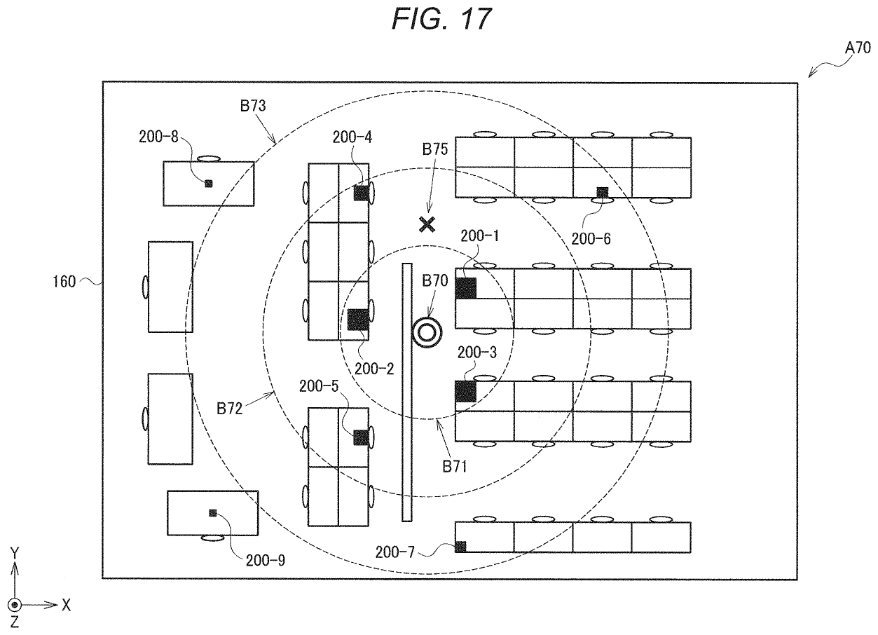

For example, on the assumption that the information processing device 100 is located at a location indicated by B60 in a screen example of A60 in FIG. 16, an area between an imaginary line indicated by B61 and an imaginary line indicated by B62 is considered to be an area that is the user's field of view and that the user can easily access. In this area, the electronic device 200-1 indicated by B61 and the electronic device 200-4 indicated by B64 exist. Therefore, the control unit 150 may highlight the form of the icons indicating the electronic device 200-1 and the electronic device 200-4, compared with the other electronic devices 200. For example, the form of the icon can be highlighted by making the color of the icons indicating the electronic device 200-1 and the electronic device 200-4 darker than the color of the icons of the other electronic devices 200, as shown in FIG. 16. However, this is not limiting. For example, the form of the icon may be highlighted by making the size of the icon larger. For example, the control unit 150 can implement the display of the screen example shown in A60 in FIG. 16 by a technique of adding processing of deciding the form of the icon displayed on the map screen, based on the location information and the direction information of each electronic device 200, of the icon data stored in the memory, not illustrated, and then reading out the corresponding icon data, or the like. In the case of FIG. 16, for example, the electronic device 200-1 and the electronic device 200-4 are the first electronic device and the other electronic devices 200 than the electronic device 200-1 and the electronic device 200-4 are the second electronic device.

The control unit 150 may also execute, for example, display processing as in a screen example shown in A70 in FIG. 17. For example, when the information processing device 100 is located at a location indicated by B70, the electronic device 200-1, the electronic device 200-2, and the electronic device 200-3 are located within a first range, which is a dashed-line range indicated by B71 away from the location of B70 by a first distance. In a second range, which is within a dashed-line range of B72 away from the location of B70 by a second distance longer than the first distance and excluding the first range, the electronic device 200-4 and the electronic device 200-5 are located. In a third range, which is within a dashed-line range of B73 away from the location of B70 by a third distance longer than the second distance and excluding the first range and the second range, the electronic device 200-6 and the electronic device 200-7 are located. In an area away from the location of B70 by a distance longer than the third distance, the electronic device 200-8 and the electronic device 200-9 are located. In this case, the control unit 150 may display an icon indicating the electronic device 200-1, an icon indicating the electronic device 200-2, and an icon indicating the electronic device 200-3 in a first size, which is the largest size. Similarly, the control unit 150 may display an icon indicating the electronic device 200-4 and an icon indicating the electronic device 200-5 in a second size, which is smaller than the first size. Similarly, the control unit 150 may display an icon indicating the electronic device 200-6 and an icon indicating the electronic device 200-7 in a third size, which is smaller than the second size. Similarly, the control unit 150 may display an icon indicating the electronic device 200-8 and an icon indicating the electronic device 200-9 in a fourth size, which is smaller than the third size. For example, the control unit 150 can implement the display of the screen example shown in A70 in FIG. 17 by a technique of adding processing of deciding the form of the icon displayed on the map screen, based on the distance information of each electronic device 200, of the icon data stored in the memory, not illustrated, and then reading out the corresponding icon data, or the like. In the example shown in FIG. 17, for example, the electronic devices 200-1 to 200-3 are the first electronic device, and the electronic device 200-4 and the electronic device 200-5 are the second electronic device. However, the combination of the first electronic device and the second electronic device is not limited to this example.

As described above, in the information processing device 100 in this embodiment, when an image of the first electronic device and an image of the second electronic device located at a location farther from the information processing device 100 than the first electronic device are displayed as images of electronic devices in the map image, the control unit 150 executes the highlight display to highlight the image of the first electronic device, compared with the image of the second electronic device. Thus, the user can accurately grasp the electronic device 200 near the information processing device 100.

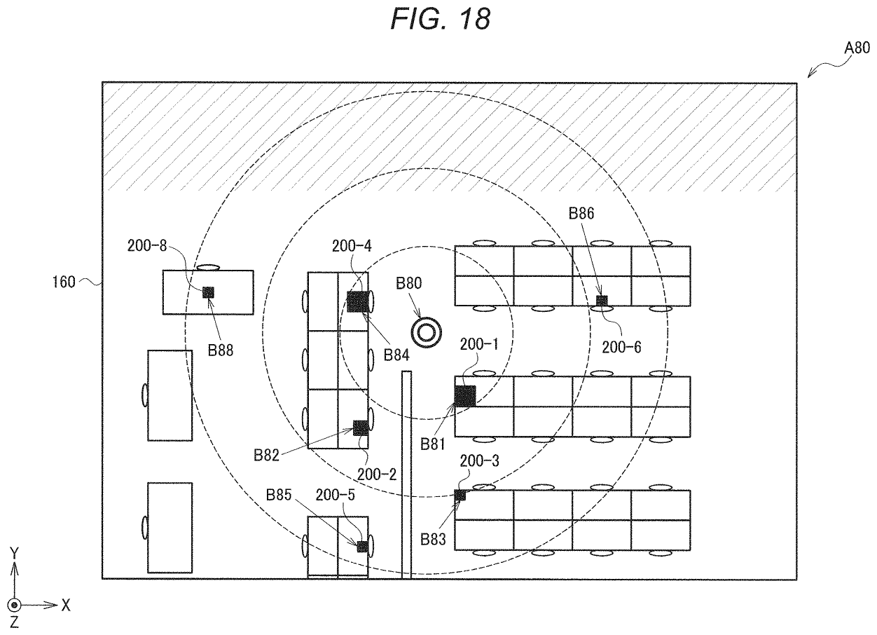

The technique in this embodiment is not limited to the above. For example, the control unit 150 may execute processing that can correct the displayed location of the information processing device 100 in response to an operation by the user. For example, it is assumed that, while the information processing device 100 is displayed as being located at the location indicated by B70 in the display example in FIG. 17, the actual information processing device 100 is located at a location corresponding to a location indicated by B75. In this case, for example, the user may tap the location indicated by B75 on the display unit 160 formed of a touch panel, and the control unit 150 may thus execute processing of changing from the screen example of A70 in FIG. 17 to a screen example shown in A80 in FIG. 18. More specifically, an icon indicating the information processing device 100 is displayed at the location indicated by B75 in FIG. 17, as indicated by B80 in FIG. 18. The control unit 150 may also execute processing of changing the first range or the like described with reference to FIG. 17, due to the correction of the location of the information processing device 100. Specifically, the control unit 150 may display an icon indicating the electronic device 200-4 in the first size, as indicated by B84, and may display an icon indicating the electronic device 200-2 in the second size, as indicated by B82. Similarly, the control unit 150 may display an icon of B83 indicating the electronic device 200-3 and an icon of B88 indicating the electronic device 200-8 in the third size.

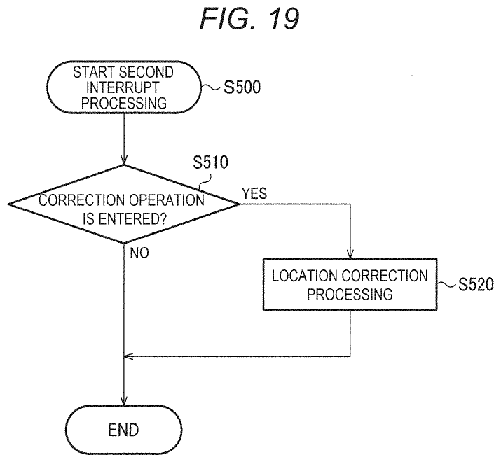

Such processing can be implemented, for example, by second interrupt processing (step S500) shown in FIG. 19. The control unit 150 executes processing of determining whether a correction operation is entered or not (step S510). When it is determined that a correction operation is not entered (NO in step S510), the control unit 150 ends the flow. When it is determined that a correction operation is entered (YES in step S510), the control unit 150 executes location correction processing (step S520).

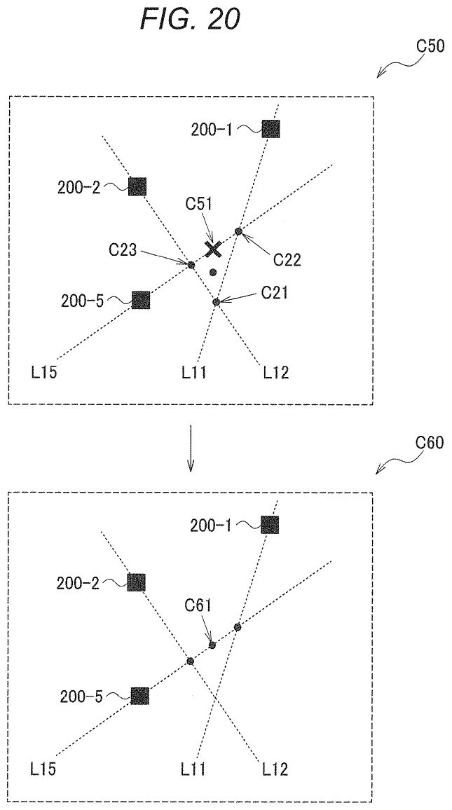

FIG. 20 shows an application example of the location correction processing (step S520) in the case where the location of the information processing device 100 is estimated by the technique shown in FIG. 11. C50 in FIG. 20 shows that the user has tapped a location indicated by C51 in a circumstance similar to FIG. 11. Thus, the control unit 150 executes processing shown in C60. Specifically, the control unit 150 executes processing of excluding the point of intersection indicated by C21 that is the most distant from the point indicated by C51, from among the point of intersection indicated by C21, the point of intersection indicated by C22, and the point of intersection indicated by C23 described above with reference to FIG. 11, and estimating a point indicated by C61 as a new location of the information processing device 100. The coordinates of the point indicated by C61 are the average of the coordinates of the point indicated by C22 and the coordinates of the point indicated by C23. In the case of this technique, when the location indicated by C51 tapped by the user is significantly far away from the actual location of the information processing device 100, the location indicated by C51 may not necessarily coincide with the location indicated by C61 estimated as the new location of the information processing device 100.

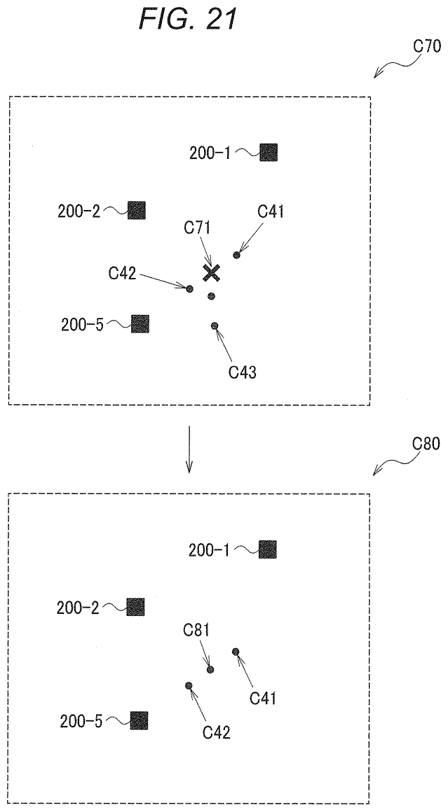

FIG. 21 shows an application example of the location correction processing (step 5520) in the case where the location of the information processing device 100 is estimated by the technique shown in FIG. 13. C70 in FIG. 21 shows that the user has tapped a location indicated by C71 in a circumstance similar to FIG. 13. Thus, the control unit 150 executes processing shown in C80. Specifically, the control unit 150 executes processing of excluding the point indicated by C43 that is the most distant from the point indicated by C71, from among the point indicated by C41, the point indicated by C42, and the point indicated by C43 described above with reference to FIG. 13, and estimating a point indicated by C81 as a new location of the information processing device 100. The coordinates of the point indicated by C81 are the average of the coordinates of the point indicated by C41 and the coordinates of the point indicated by C42.

As described above, in the information processing device 100 in this embodiment, the control unit 150 executes the correction processing of correcting the location of the information processing device 100 in the map image, based on input information from the user. Thus, the location of the information processing device 100 can be estimated more accurately. For example, when the BLE radio wave outputted from the BLE communication unit 212 includes a noise due to a malfunction or the like of the electronic device 200, the control unit 150 may not be able to accurately estimate the location of the information processing device 100. In this regard, by applying the technique in this embodiment, a factor that lowers the accuracy of the estimation of the location of the information processing device 100 can be eliminated.

In the above example shown in FIG. 21, the point indicated by C43, excluded as a target of the correction processing, is a point indicating the location of the information processing device 100 estimated from the electronic device 200-5. Thus, for example, when the user has tapped the point indicated by C71, processing of setting the electronic device 200-5 as a predetermined electronic device excluded from the selection target may be added in the subsequent location calculation processing (step S200) and the like shown in FIG. 2 and the like. This is because trouble in the BLE communication unit 212 or the like of the electronic device 200-5, if any, is considered to adversely affect the accuracy of the location estimation of the information processing device 100 in the subsequent location calculation processing (step S200). Thus, the electronic device 200-5, which is the predetermined electronic device, is set as an exclusion target device in the correction processing and is not selected in the subsequent location calculation processing (step S200) of the information processing device 100. While only one point is excluded as a target of the correction processing in the examples shown in FIGS. 20 and 21, two or more points may be excluded. As described above, in the information processing device 100 in this embodiment, after executing, based on the input information from the user, the correction processing of excluding a predetermined electronic device of an electronic device group including the electronic device 200 from the acquisition target of the location information of the information processing device 100 based on the direction information, the control unit 150 sets the predetermined electronic device as an exclusion target device in the correction processing. Thus, the estimation of the location of the information processing device 100 based on the electronic device 200 that may have communication trouble can be prevented. Therefore, the location of the information processing device 100 can be estimated more accurately.

The technique of the location correction processing (step S520) is not limited to the above example. For example, in the example shown in C70 in FIG. 21, the point indicated by C42, which is the nearest to the location indicated by C71 tapped by the user from among the point indicated by C41, the point indicated by C42, and the point indicated by C43, may be defined as a new estimated location of the information processing device 100. Also, for example, the information processing device 100 may include a plurality of types of processing modes of the location correction processing (step S520), and the user may be able to select a suitable processing mode. Also, the information processing device 100 may include, for example, a processing mode in which the coordinates on the map information tapped by the user are compulsorily set as the coordinates of the location of the information processing device 100, in addition to the processing mode based on the above technique. This is because there may be a case where the BLE radio wave environment is poor on the entire floor based on the map information.

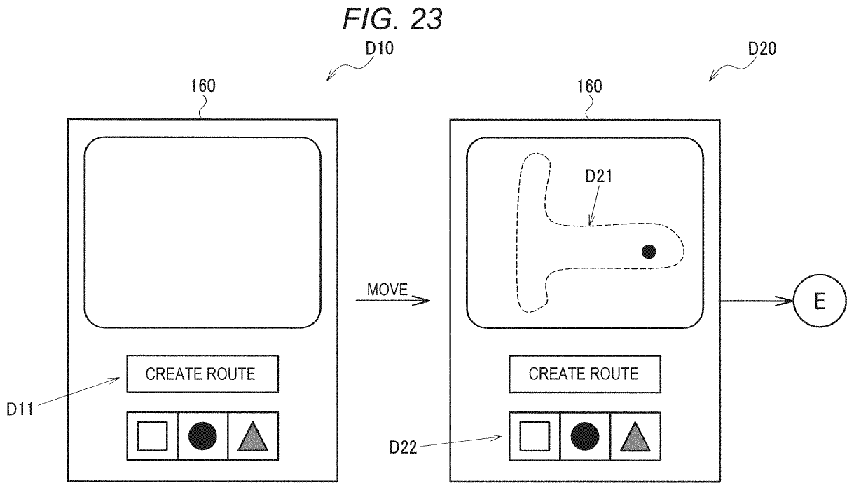

The technique in this embodiment is not limited to the above and can be implemented with various modifications. For example, as a modification example of the information processing device 100, a configuration example shown in FIG. 22 may be employed. The modification example shown in FIG. 22 differs from the configuration example shown in FIG. 1 in that the information processing device 100 further includes a map information generation unit 170. The map information generation unit 170 executes generation processing for map information. For example, though not illustrated, in response to the user selecting a predetermined icon or the like on the map screen, a map information generation application program starts and a map information editing screen described later with reference to FIG. 23 or the like is displayed. The map information generation unit 170 then generates map information, based on an editing operation by the user, described later. Subsequently, the information processing device 100 executes the processing shown in FIG. 2 or the like, based on the generated map information, and thus can implement the display of a map screen based on the generated map information.

As described above, the information processing device 100 in this embodiment further includes the map information generation unit 170 executing the generation processing for map information, based on an editing by the user. Thus, the convenience of the information processing device 100 can be improved. For example, there may be a case where a background image corresponding to the map screen of A0 in FIG. 3 cannot be prepared in advance. In this regard, by applying the technique in this embodiment, the control unit 150 can display a map screen based on a simplified background image. Thus, the convenience of the information processing device 100 can be improved.

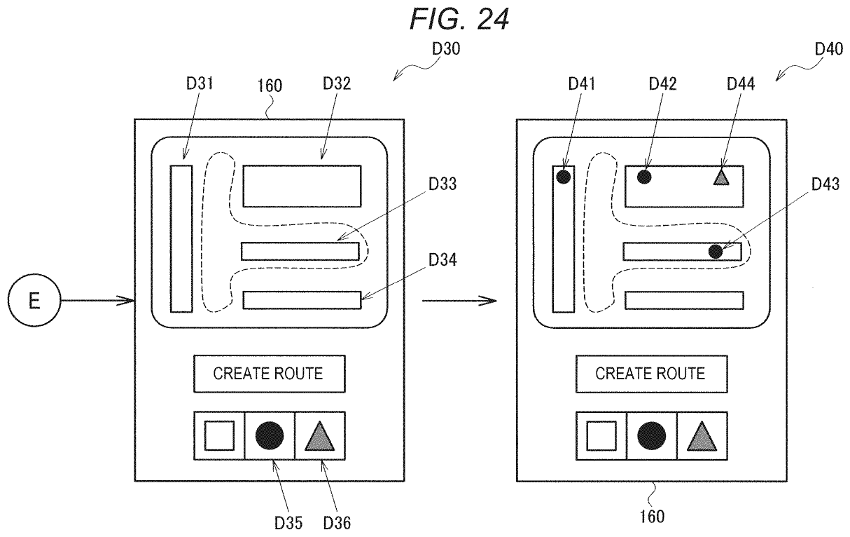

A screen example of the map information generation application will now be described, using FIGS. 23 and 24. As the user starts the map information generation application program, the control unit 150 displays, for example, a screen shown in D10 on the display unit 160. The user selects an icon indicated by D11 and moves through a predetermined path on the floor, holding the information processing device 100. Thus, a screen example shown in D20 is displayed on the display unit 160. Specifically, a history of movement of the user is displayed, for example, as a dashed-line trajectory as indicated by D21. The technique for displaying the trajectory is sufficiently known and therefore is not described further here. In this way, in the information processing device 100 in this embodiment, the control unit 150 executes the processing of displaying a history of movement of the information processing device 100 in a map image. Thus, the user can easily create a map image.

The user then selects an icon indicated by D22. The icon indicated by D22 is an icon for arranging a predetermined geometric shape in the screen on the display unit. The user arranges the predetermined geometric shape as a part corresponding to a desk or a wall, referring to the trajectory indicated by D21. In FIG. 23, for example, a rectangular shape is shown as the predetermined geometric shape. However, other geometric shapes may be selectable and an image of a desk, a chair, a cabinet or the like may be used. Thus, for example, a screen example shown in D30 in FIG. 24 is displayed on the display unit 160. Specifically, predetermined geometric shapes indicated by D31, D32, D33, D34 are arranged and a simplified background image is generated. Subsequently, the user selects, for example, an icon indicated by D35. The icon indicated by D35 is an icon for indicating the arrangement of the fixed-location electronic device 200. On the display unit 160, for example, a screen example shown in D40 in FIG. 24 is displayed. Specifically, map information including information that the electronic device 200 is arranged at locations indicated by D41, D42, D43 is generated. When the icons indicated by D41, D42, D43 are arranged, the control unit 150 may execute processing of automatically storing location information of the icons in the memory, not illustrated. The user may suitably use a plurality of types of icons in order to be able to distinguish the electronic devices 200 further. For example, an icon indicated by D36 may be an icon for arranging the mobile electronic device 200, and the icon indicating the mobile electronic device 200 may be arranged at a location of D44 in the screen example of D40. In this case, the control unit 150 need not store location information of the icon indicated by D44 in the memory, not illustrated.

The user who has generated map information may be able to transmit the map information to the information processing device 100 of another user. For example, the BLE communication unit 112 of the wireless communication unit 110 of the information processing device 100 held by the user who has created map information and the BLE communication unit 112 of the wireless communication unit 110 of the information processing device 100 held by another user may be connected to each other and thus can implement the transmission and reception of the map information. Also, for example, the users may transmit and receive the map information by establishing Wi-Fi connection. Also, the user who has created map information may store the map information in a predetermined server. The transmission and reception of the map information can also be implemented by various other techniques. In this way, in the information processing device 100 in this embodiment, the control unit 150 transmits the map information generated by the map information generation unit 170 to another information processing device 100 via the wireless communication unit 110. Thus, the users moving on the floor according to the generated map information can share the generated map information and can use the map information as a map image.

As described above, the information processing device according to this embodiment is an information processing device wirelessly communicating with an electronic device via a wireless communication unit. The information processing device includes a search result acquisition unit, a direction information acquisition unit, a map information acquisition unit, and a control unit. The search result acquisition unit acquires information of a search result about the electronic device by a search via the wireless communication unit. The direction information acquisition unit acquires direction information representing a direction in which the electronic device found by the search exists, based on short-range wireless communication with the electronic device via the wireless communication unit. The map information acquisition unit acquires map information including location information of the electronic device found by the search. The control unit acquires the location information of the information processing device specified based on the direction information and the map information, and displays information representing a location of the information processing device in a map image corresponding to the map information, based on the location information of the information processing device.

Thus, a user can grasp the location of the information processing device in the map image in detail. The user can thus grasp the positional relationship between the information processing device and the electronic device in the map image more in detail. Therefore, for example, when a plurality of electronic devices exist in the map image, the user can properly determine which electronic device to select.

The control unit may change a display form of an image of the electronic device in the map image according to a status of the electronic device.

Thus, the user can further take the status of the electronic device into consideration and therefore can select the electronic device more properly.

The control unit may display information representing a direction of the information processing device in the map image.

Thus, the user can grasp which direction the information processing device faces.

The control unit may execute rotation processing of the map image, based on the direction of the information processing device.

Thus, the map image based on the direction in which the information processing device faces as a reference position can be displayed.

When an image of a first electronic device and an image of a second electronic device located at a location father from the information processing device than the first electronic device are displayed as an image of the electronic device in the map image, the control unit may execute highlight display to highlight the image of the first electronic device, compared with the image of the second electronic device.

Thus, the user can accurately grasp the electronic device near the information processing device.

The control unit may execute correction processing of correcting the location of the information processing device in the map image, based on input information from the user.

Thus, the location of the information processing device can be estimated more accurately.

After executing, based on the input information from the user, the correction processing of excluding a predetermined electronic device of an electronic device group including the electronic device from an acquisition target of the location information of the information processing device based on the direction information, the control unit may set the predetermined electronic device as an exclusion target device in the correction processing.

Thus, the estimation of the location of the information processing device based on the electronic device that may have communication trouble can be prevented.

The information processing device may further include a map information generation unit executing generation processing for the map information, based on an editing by the user.

Thus, the convenience of the information processing device can be improved.

The control unit may transmit the map information generated by the map information generation unit to another information processing device via the wireless communication unit.

Thus, the users moving on the floor according to the generated map information can share the generated map information and can use the map information as a map image.

The control unit may execute processing of displaying a history of movement of the information processing device in the map image.

Thus, the user can easily create a map image.

When another electronic device that is not included in the map information is detected, the control unit may execute processing of displaying an image of the another electronic device on the map image, based on the direction information of the another electronic device, the map information, and the location information of the information processing device.

Thus, the user can grasp another electronic device that is not included in the map information, on the map screen.

The program according to this embodiment relates to a program causing a computer to operate as a wireless communication unit, a search result acquisition unit, a direction information acquisition unit, a map information acquisition unit, and a control unit. The wireless communication unit wirelessly communicates with an electronic device. The search result acquisition unit acquires information of a search result about the electronic device by a search via the wireless communication unit. The direction information acquisition unit acquires direction information representing a direction in which the electronic device found by the search exists, based on short-range wireless communication with the electronic device via the wireless communication unit. The map information acquisition unit acquires map information including location information of the electronic device found by the search. The control unit acquires the location information of an information processing device specified based on the direction information and the map information, and displays information representing a location of the information processing device in a map image corresponding to the map information, based on the location information of the information processing device.

The embodiment has been described above in detail. However, a person skilled in the art can readily understand that various modifications can be made without substantially departing from the new matters and effects of the embodiment. Therefore, all such modification examples are included in the scope of the present disclosure. For example, in the specification or the drawings, a term described along with a different term having a broader meaning or the same meaning, at least once, can be replaced with the different term at any point in the specification or the drawings. Also, all combinations of the embodiment and modification examples are included in the scope of the present disclosure. The configurations and operations of the information processing device and the program or the like are not limited to those described in the embodiment and can be implemented with various modifications.

What is claimed is:

1. An information processing device wirelessly communicating with an electronic device via a wireless communication unit, the information processing device comprising:
a search result acquisition unit acquiring information of a search result about the electronic device by a search via the wireless communication unit;
a direction information acquisition unit acquiring direction information representing a direction in which the electronic device found by the search exists, based on short-range wireless communication with the electronic device via the wireless communication unit;
a map information acquisition unit acquiring map information including location information of the electronic device found by the search; and
a controller acquiring the location information of the information processing device specified based on the direction information and the map information, and displaying information representing a location of the information processing device in a map image corresponding to the map information, based on the location information of the information processing device.

2. The information processing device according to claim 1, wherein
the controller changes a display form of an image of the electronic device in the map image according to a status of the electronic device.

3. The information processing device according to claim 1, wherein
the controller displays information representing a direction of the information processing device in the map image.

4. The information processing device according to claim 1, wherein
the controller executes rotation processing of the map image, based on a direction of the information processing device.

5. The information processing device according to claim 1, wherein
when an image of a first electronic device and an image of a second electronic device located at a location father from the information processing device than the first electronic device are displayed as an image of the electronic device in the map image, the controller executes highlight display to highlight the image of the first electronic device, compared with the image of the second electronic device.

6. The information processing device according to claim 1, wherein
the controller executes correction processing of correcting the location of the information processing device in the map image, based on input information from a user.

7. The information processing device according to claim 6, wherein
after executing, based on the input information from the user, the correction processing of excluding a predetermined electronic device of an electronic device group including the electronic device from an acquisition target of the location information of the information processing device based on the direction information, the controller sets the predetermined electronic device as an exclusion target device in the correction processing.

8. The information processing device according to claim 1, further comprising:
a map information generator executing generation processing for the map information, based on an editing by a user.

9. The information processing device according to claim 8, wherein
the controller transmits the map information generated by the map information generator to another information processing device via the wireless communication unit.

10. The information processing device according to claim 1, wherein
the controller executes processing of displaying a history of movement of the information processing device in the map image.

11. The information processing device according to claim 1, wherein
when another electronic device that is not included in the map information is detected, the controller executes processing of displaying an image of the another electronic device on the map image, based on the direction information of the another electronic device, the map information, and the location information of the information processing device.

12. A non-transitory computer-readable storage medium storing a program, the program causing a computer to function as:
a wireless communication unit wirelessly communicating with an electronic device;
a search result acquisition unit acquiring information of a search result about the electronic device by a search via the wireless communication unit;
a direction information acquisition unit acquiring direction information representing a direction in which the electronic device found by the search exists, based on short-range wireless communication with the electronic device via the wireless communication unit;
a map information acquisition unit acquiring map information including location information of the electronic device found by the search; and
a controller acquiring the location information of an information processing device specified based on the direction information and the map information, and displaying information representing a location of the information processing device in a map image corresponding to the map information, based on the location information of the information processing device.
